(19) United States
(12) Patent Application Publication
(10) Pub. No.: US 2026/0219044 A1
(43) Pub. Date: Jul. 30, 2026

(54) SYSTEM AND METHOD FOR OUT OF SEQUENCE MEASUREMENT PROCESSING WITH UNCERTAIN MODELS

(71) Applicant: TOYOTA RESEARCH INSTITUTE, INC., Los Altos, CA (US)

(72) Inventors: Carl Marcus GREIFF, Sunnyvale, CA (US); Thomas J. LEW, Mountain View, CA (US); John Karl SUBOSITS, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/038,546

(22) Filed: Jan. 27, 2025

(51) Int. Cl. G01C 21/16; G01S 19/39

(52) U.S. Cl. CPC G01C 21/1652; G01S 19/39

(57) ABSTRACT

A method for out of sequence measurement (OOSM) state estimation is described. The method includes forward predicting a head estimate of a buffer computed at a current time to a future time to provide a first particle. The method also includes forward predicting the head estimate computed at the current time and an out of sequence measurement (OOSM) to the future time as a second particle. The method further includes forward predicting the head estimate computed at the current time without the OOSM to the future time as a third particle. The method also includes updating the head estimate of the buffer according to a fusion of the first particle, the second particle, and the third particle.

### BACKGROUND

### Field

Certain aspects of the present disclosure relate to autonomous vehicle technology and, more particularly, to a system and method for out of sequence measurement processing with uncertain models.

### Background

Autonomous agents (e.g., vehicles, robots, etc.) rely on machine vision and sensors (inertial measurement unit (IMU) information, GPS, etc.) for estimating an agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with a higher-level number offers a greater combination and quantity of autonomous features relative to the other vehicle.

Autonomous driving (AD) as well as autonomous racing (AR) technologies rely on various sensing modalities for fusing available information into an estimate of a vehicle state. When considering less reliable sensory information, it becomes imperative to estimate this reliability (e.g., noise statistics of an estimation model). A variational filtering method for safely enabling to the noted autonomous driving (AD) and autonomous racing (AR) technologies is desired.

### SUMMARY

A method for out of sequence measurement (OOSM) state estimation is described. The method includes forward predicting a head estimate of a buffer computed at a current time to a future time to provide a first particle. The method also includes forward predicting the head estimate computed at the current time and an out of sequence measurement (OOSM) to the future time as a second particle. The method further includes forward predicting the head estimate computed at the current time without the OOSM to the future time as a third particle. The method also includes updating the head estimate of the buffer according to a fusion of the first particle, the second particle, and the third particle.

A non-transitory computer-readable medium having program code recorded thereon for out of sequence measurement (OOSM) state estimation is described. The program code is executed by a processor. The non-transitory computer-readable medium includes program code to forward predict a head estimate of a buffer computed at a current time to a future time to provide a first particle. The non-transitory computer-readable medium also includes program code to forward predict the head estimate computed at the current time and an out of sequence measurement (OOSM) to the future time as a second particle. The non-transitory computer-readable medium further includes program code to forward predict the head estimate computed at the current time without the OOSM to the future time as a third particle. The non-transitory computer-readable medium also includes program code to update the head estimate of the buffer according to a fusion of the first particle, the second particle, and the third particle.

A system for out of sequence measurement (OOSM) state estimation is described. The system includes a head estimate prediction module to forward predict a head estimate of a buffer computed at a current time to a future time to provide a first particle. The system also includes a head estimate branching model to forward predict the head estimate computed at the current time and an out of sequence measurement (OOSM) to the future time as a second particle and to forward predict the head estimate computed at the current time without the OOSM to the future time as a third particle. The system further includes a particle fusion module to update the head estimate of the buffer according to a fusion of the first particle, the second particle, and the third particle. The system also includes a vehicle state estimation module to estimate a vehicle state based on the updated head estimate of the buffer according to the fusion of the first particle, the second particle, and the third particle.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings, in which like reference characters identify correspondingly throughout.

FIG. 1 illustrates an example implementation using a system-on-a-chip (SOC) for an out of sequence measurement (OOSM) vehicle state estimation system, in accordance with aspects of the present disclosure.

FIG. 2 is a block diagram illustrating a software architecture that may modularize artificial intelligence (AI) functions for an out of sequence measurement (OOSM) vehicle state estimation system, according to aspects of the present disclosure.

FIG. 3 is a diagram illustrating an example of a hardware implementation for an out of sequence measurement (OOSM) vehicle state estimation system, according to aspects of the present disclosure.

FIGS. 4A and 4B are block diagrams illustrating a vehicle configured with an out of sequence measurement (OOSM) vehicle state estimation system, according to aspects of the present disclosure.

FIG. 5 illustrates a forward prediction combined with fusion and decorrelation (FPFD) process for fusing various sensing modalities into a description of the vehicle state, according to various aspects of the present disclosure.

FIG. 5 illustrates a lane keeping assist (LKA) system during simulated operation of a vehicle, according to aspects of the present disclosure.

FIG. 6 is a flowchart illustrating an out of sequence measurement (OOSM) vehicle state estimation process, according to various aspects of the present disclosure.

FIG. 7 is a flowchart illustrating a process for prediction of an Inverse-Wishart-Gaussian particle, according to various aspects of the present disclosure.

FIG. 8 is a flowchart illustrating a process for updating an Inverse-Wishart-Gaussian particle, according to various aspects of the present disclosure.

FIG. 9 is a diagram illustrating variational updates, according to various aspects of the present disclosure.

FIG. 10 is a flowchart illustrating a method for an out of sequence measurement (OOSM) vehicle state estimation, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., vehicles, robots, etc.) rely on machine vision and sensors (IMU, GPS, etc.) for estimating an agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with a higher-level number offers a greater combination and quantity of autonomous features relative to the other vehicle.

Estimating a vehicle state is a problem that is at the core of autonomous driving (AD) and autonomous racing (AR) technologies. In practice, a vehicle state is estimated by fusing available information from various sensing modalities into an estimate of the vehicle state. Unfortunately, fusing available information from various sensing modalities may involve less reliable sensory information. Estimating this reliability is imperative for determining noise statistics of a vehicle state estimation model. For example, a noise adaptive variational filtering process may be utilized to for determining noise statistics of the vehicle state estimation model.

Noise adaptive variational filtering processes assume that all the measurements are available and processed in the order that they are sampled. Unfortunately, due to delays in acquiring the sensory information (e.g., computation times in image processing), certain measurements may arrive with a significant delay, while more recent measurements are processed. Utilization of the noted noise adaptive variational filtering process involves out of sequence measurement (OOSM) processing. As a result, there is a need for a vehicle state in autonomous driving (AD) and autonomous racing (AR) technologies to support OOSM processing when using noise adaptive variational filtering processes. Various aspects of the present disclosure apply variational filtering methods for estimating a vehicle state in autonomous driving (AD) and autonomous racing (AR) technologies.

Various aspects of the present disclosure are directed to a system and method for processing out of sequence measurements (OOSMs) of a latent state vector including values indicative of the noise covariance of the estimation model. That is, measurements are received some time after they are sampled, and which are specified for instant processing to generate an estimate of the underlying vehicle state. Some implementations are directed to an estimation algorithm that adapts and estimates both the state but also the uncertainty of the estimation model.

It is understood that while the disclosed OOSM vehicle estimation system supports measurements that arrive out of sequence, in the manner previously described, it can also simultaneously process measurements that arrive in sequence. In one embodiment, at least one sensor is configured to provide in sequence measurements, where another sensor is configured to provide out of sequence measurements. For example, the measurements from a GPS system may arrive at low rates and be delayed due to internal processing of the GPS chipset and may need to be processed out of sequence. In contrast, the IMU measurements may arrive at higher rates and can be processed in sequence. In such embodiments, the in-sequence measurements are incorporated using standard filtering frameworks, such as the variational Kalman filters mentioned previously, whereas the out of sequence measurements are processed with the particle-based prediction, decorrelation, and fusion methodology.

In practice, this processing is computationally demanding, yet often superior for applications where noise statistics are uncertain or time varying. Examples of noise statistics that are uncertain or time varying include driving applications (regular and racing), where the reliability of the global navigation satellite system (GNSS) information may vary in time, or late sensor fusion with optical flow where noise may increase during changing lighting conditions. Additionally, examples of noise statistics that are uncertain or time varying include auxiliary measurements, such as road-geometry detection, the tracking of classical corner features, or any other information that may indicate the state of the vehicle from the visual information gathered in the cameras. Various aspects of the present disclosure are directed to a system and method for performing OOSMs in a variational filtering setting, applicable to a large family of noise adaptive filters, focusing on implementations related to driving.

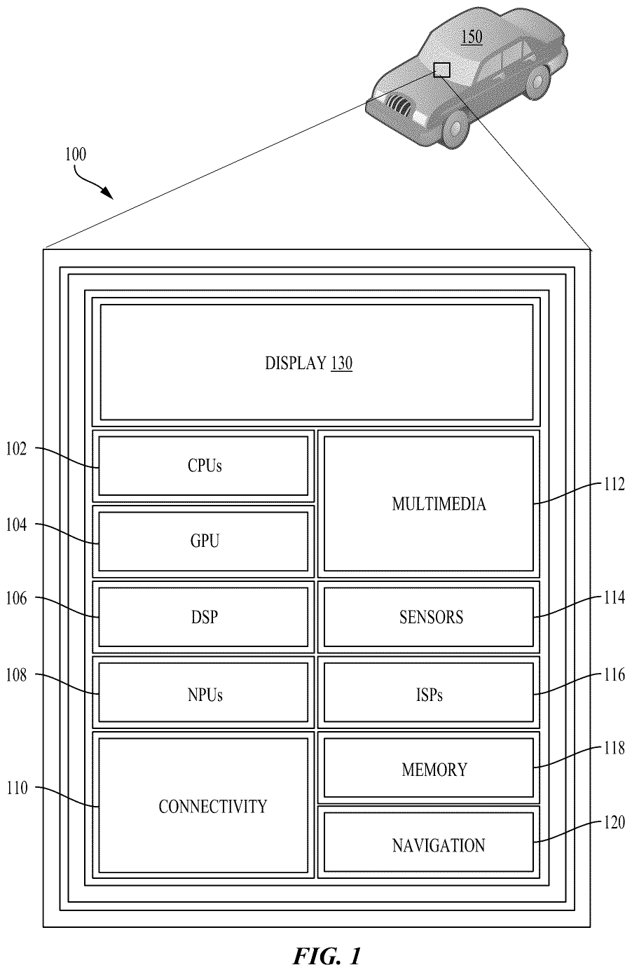

FIG. 1 illustrates an example implementation of the aforementioned system and method for an out of sequence measurement (OOSM) vehicle state estimation system using a system-on-a-chip (SOC) 100 of a vehicle 150. The SOC 100 may include a single processor or multicore processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system (GPS).

The SOC 100 may be based on an Advanced Risk Machine (ARM) instruction set or the like. In another aspect of the present disclosure, the SOC 100 may be a server computer in communication with the vehicle 150. In this arrangement, the vehicle 150 may include a processor and other features of the SOC 100. In this aspect of the present disclosure, instructions loaded into a processor (e.g., the CPU 102) or the NPU 108 of the vehicle 150 may include program code to perform out of sequence measurement (OOSM) vehicle state estimation. For example, the OOSM vehicle state estimation system is particularly useful for applications with delayed and unreliable measurements, such as in driving technologies.

The instructions loaded into a processor (e.g., the NPU 108) may also include program code to predict a head estimate of a buffer to a current time for providing a first particle. The instructions loaded into a processor (e.g., the NPU 108) may also include program code to predict and update a closest preceding estimate in the buffer without an OOSM to form a second particle. The instructions loaded into a processor (e.g., the NPU 108) may also include program code to predict and update the closest preceding estimate in the buffer with the OOSM to form a third particle. The instructions loaded into a processor (e.g., the NPU 108) may also include program code to update the head estimate of the buffer according to a fusion of the first particle, the second particle, and the third particle.

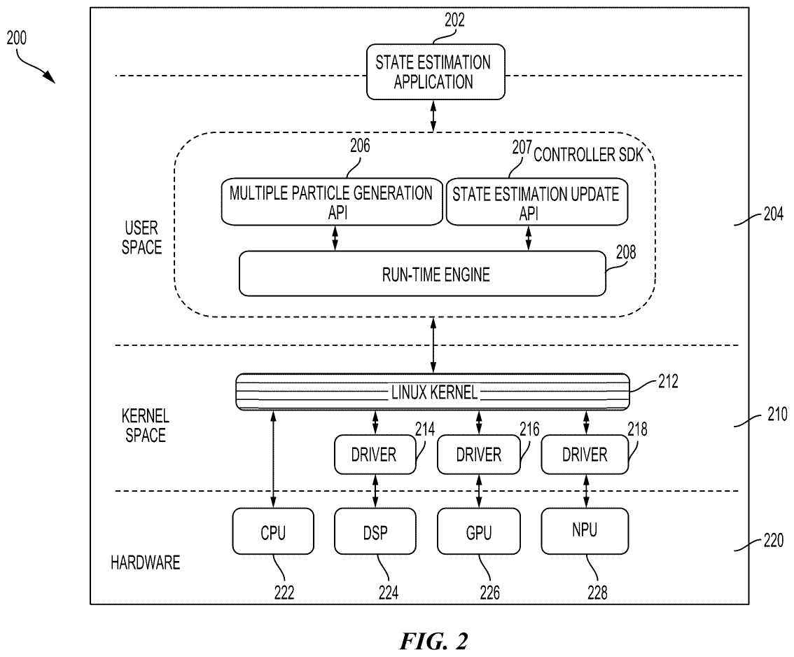

FIG. 2 is a block diagram illustrating a software architecture 200 that may modularize artificial intelligence (AI) functions for an out of sequence measurement (OOSM) vehicle state estimation system, according to aspects of the present disclosure. Using the software architecture 200, a state estimation application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the state estimation application 202. While FIG. 2 describes the software architecture 200 for vehicle state estimation features, it should be recognized that the state estimation features are not limited to autonomous driving (AD) as well as autonomous racing (AR). According to aspects of the present disclosure, the OOSM vehicle state estimation system is applicable to any applications with delayed and unreliable measurements.

The state estimation application 202 may be configured to call functions defined in a user space 204 that may, for example, provide for vehicle state estimation for providing improved autonomous driving (AD) as well as autonomous racing (AR) services. The state estimation application 202 may make a request to compile program code associated with a library defined in a multiple particle generation application programming interface (API) 206 to forward predict a head estimate of a buffer computed at a current time to a future time for providing a first particle.

Additionally, the multiple particle generation API 206 forward predicts the head estimate of the buffer computed at the current time and an OOSM to the future time to form a second particle, and to forward predict the head estimate of the buffer computed at the current time without the OOSM to the future time to form a third particle. The state estimation application 202 may also make a request to compile program code associated with a library defined in a state estimation update API 207 to update the head estimate of the buffer according to a fusion of the first particle, the second particle, and the third particle. In response, a vehicle state is estimated based on the updated head estimate of the buffer.

A run-time engine 208, which may be compiled code of a runtime framework, may be further accessible to the state estimation application 202. The state estimation application 202 may cause the run-time engine 208, for example, to take actions for estimating a vehicle state. When the various particles are fused, the run-time engine 208 may in turn send a signal to an operating system 210, such as a Linux Kernel 212, running on the SOC 220. FIG. 2 illustrates the Linux Kernel 212 as software architecture for estimating a vehicle safety. It should be recognized, however, that aspects of the present disclosure are not limited to this exemplary software architecture. For example, other kernels may be used to provide the software architecture to support the vehicle state estimation functionality to any applications with delayed and unreliable measurements.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a dynamic model may be configured to run on a combination of processing blocks, such as the CPU 222 and the GPU 226, or may be run on the NPU 228 if present.

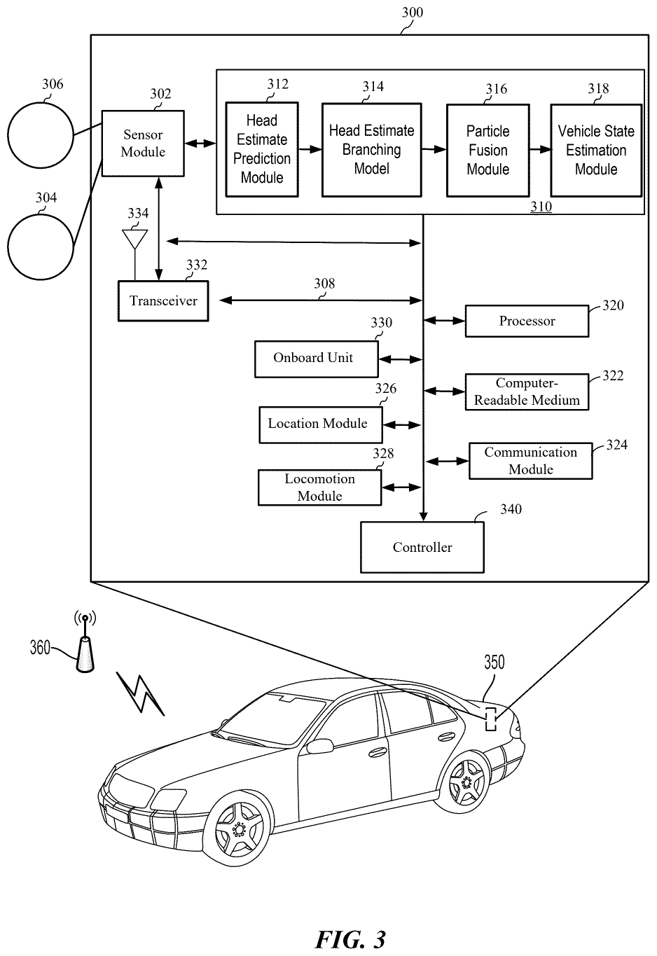

FIG. 3 is a diagram illustrating an example of a hardware implementation for an out of sequence measurement (OOSM) vehicle state estimation system 300, according to aspects of the present disclosure. The OOSM vehicle state estimation system 300 may be configured to estimate a state of a vehicle 350 when measurements from the vehicle 350 are received some time after they are sampled, and which are specified for instant processing to generate an estimate of the underlying state of the vehicle 350. The OOSM vehicle state estimation system 300 may be a component of a vehicle or other non-autonomous device (e.g., non-autonomous vehicles). For example, as shown in FIG. 3, the OOSM vehicle state estimation system 300 is a component of the vehicle 350.

Aspects of the present disclosure are not limited to the OOSM vehicle state estimation system 300 being a component of the vehicle 350. Other devices, such as a bus, motorcycle, or other like non-autonomous vehicle, are also contemplated for implementing the OOSM vehicle state estimation system 300. In this example, the vehicle 350 may be autonomous or semi-autonomous; however, other configurations for the vehicle 350 are contemplated, such as an advanced driver assistance system (ADAS).

The OOSM vehicle state estimation system 300 may be implemented with an interconnected architecture, such as a controller area network (CAN) bus, represented by an interconnect 308. The interconnect 308 may include any number of point-to-point interconnects, buses, and/or bridges depending on the specific application of the OOSM vehicle state estimation system 300 and the overall design constraints. The interconnect 308 links together various circuits including one or more processors and/or hardware modules, represented by a sensor module 302, a vehicle state-based planner 310, a processor 320, a computer-readable medium 322, a communication module 324, a location module 326, a locomotion module 328, an onboard unit 330, and a controller 340. The interconnect 308 may also link various other circuits such as timing sources, peripherals, voltage regulators, and power management circuits, which are well known in the art, and therefore, will not be described further.

The OOSM vehicle state estimation system 300 includes a transceiver 332 coupled to the sensor module 302, the vehicle state-based planner 310, the processor 320, the computer-readable medium 322, the communication module 324, the location module 326, the locomotion module 328, the onboard unit 330, and the controller 340. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the vehicle state-based planner 310 to/from connected vehicles within the vicinity of the vehicle 350.

The OOSM vehicle state estimation system 300 includes the processor 320 coupled to the computer-readable medium 322. The processor 320 performs processing, including the execution of software stored on the computer-readable medium 322 to provide functionality according to the disclosure. The software, when executed by the processor 320, causes the OOSM vehicle state estimation system 300 to process out of sequence measurements (OOSMs) of a latent state vector including values indicative of the noise covariance of the estimation model. The OOSM vehicle state estimation system 300 is further configured to process measurements are received some time after they are sampled, and which are specified for instant processing to generate an estimate of the underlying vehicle state as well as an uncertainty of the estimation model. The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the aforementioned sensors as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the vehicle state-based planner 310, the communication module 324, the location module 326, the locomotion module 328, the onboard unit 330, and/or the controller 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the vehicle 350 or may be in communication with the vehicle 350.

The location module 326 may determine a location of the vehicle 350. For example, the location module 326 may use a global positioning system (GPS) to determine the location of the vehicle 350. The location module 326 may implement a dedicated short-range communication (DSRC)-compliant GPS unit. A DSRC-compliant GPS unit includes hardware and software to make the vehicle 350 and/or the location module 326 compliant with one or more of the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 332. For example, the communication module 324 may be configured to provide communication capabilities via different wireless protocols, such as 6G, 5G NR, WiFi, long term evolution (LTE), 4G, 3G, etc. The communication module 324 may also communicate with other components of the vehicle 350 that are not modules of the OOSM vehicle state estimation system 300. The transceiver 332 may be a communications channel through a network access point 360. The communications channel may include DSRC, 6G, 5G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V2X, LTE-D2D, VoLTE, or any other mobile data network or combination of mobile data networks. Further, the network access point 360 may include one or more IEEE 802.11 wireless networks.

The OOSM vehicle state estimation system 300 also includes the controller 340 for planning a route and controlling the locomotion of the vehicle 350, via the locomotion module 328 for autonomous operation of the vehicle 350. In one configuration, the controller 340 may override a user input when the user input is expected (e.g., predicted) to cause a collision according to an autonomous level of the vehicle 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the vehicle 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The vehicle state-based planner 310 may be in communication with the sensor module 302, the processor 320, the computer-readable medium 322, the communication module 324, the location module 326, the locomotion module 328, the onboard unit 330, the transceiver 332, and the controller 340. In one configuration, the vehicle state-based planner 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the vehicle state-based planner 310 may receive sensor data directly from the first sensor 306 and the second sensor 304 to determine, for example, input traffic data images.

Estimating a vehicle state of the vehicle 350 is a problem that is at the core of autonomous driving (AD) and autonomous racing (AR) technologies. In practice, a vehicle state is estimated by fusing available information from various sensing modalities into an estimate of the vehicle state. Unfortunately, fusing available information from various sensing modalities may involve less reliable sensory information. In particular, vehicle measurements are received some time after they are sampled; however, the vehicle measurements are specified for instant processing to generate an estimate of the underlying state of the vehicle 350. Additionally, estimating this reliability is imperative for determining noise statistics of a vehicle state estimation model.

Various aspects of the present disclosure are directed to a system and method for processing out of sequence measurements (OOSMs) of a latent state vector including values indicative of the noise covariance of the estimation model. Although certain vehicle measurements are received some time after they are sampled, these delayed vehicle measurements are specified for instant processing to generate an estimate of the underlying vehicle state. Various aspects of the present disclosure are directed to a system and method for processing OOSMs in a variational filtering setting, applicable to a large family of noise adaptive filters, focusing on implementations related to driving.

Some implementations are directed to an estimation algorithm that adapts and estimates both the state and the uncertainty of a vehicle state estimation model. In practice, this processing is computationally demanding, yet often superior for applications where noise statistics are uncertain or time varying. Examples of noise statistics that are uncertain or time varying include driving applications (regular and racing). For example, the reliability of a global navigation satellite system (GNSS) positioning module may vary in time, or late sensor fusion with optical flow becomes less reliable as noise increases during changing lighting conditions. According to various aspects of the present disclosure, the OOSM vehicle state estimation system 300 applies variational filtering methods for estimating a vehicle state in autonomous driving (AD) and autonomous racing (AR) technologies, such as variational filtering of OOSMs.

As shown in FIG. 3, the OOSM vehicle state estimation system 300 includes the vehicle state-based planner 310 that includes a head estimate prediction module 312, a head estimate branching model 314, a particle fusion module 316, and a vehicle state estimation module 318. The head estimate prediction module 312, the head estimate branching model 314, the particle fusion module 316, and/or the vehicle state estimation module 318 may be implemented using a convolutional neural network (CNN). The vehicle state-based planner 310 is not limited to a CNN.

The head estimate prediction module 312 is configured to forward predict a head estimate of a measurement buffer computed at a current time to a future time as a first particle. Once the first particle is predicted, the head estimate branching model 314 is configured to forward predict the head estimate of the measurements buffer computed at the current time and an OOSM to a future time as a second particle. Additionally, the head estimate branching model 314 is further configured to forward predict the head estimate of the measurements buffer computed at the current time without the OOSM to a future time as a third particle. Subsequently, the particle fusion module 316 is configured to fuse the first particle, the second particle, and the third particle. Additionally, the vehicle state estimation module 318 is configured to update the head estimate of the measurements buffer, which is performed according to the fusion of the first particle, the second particle, and the third particle to estimate a state of the vehicle 350.

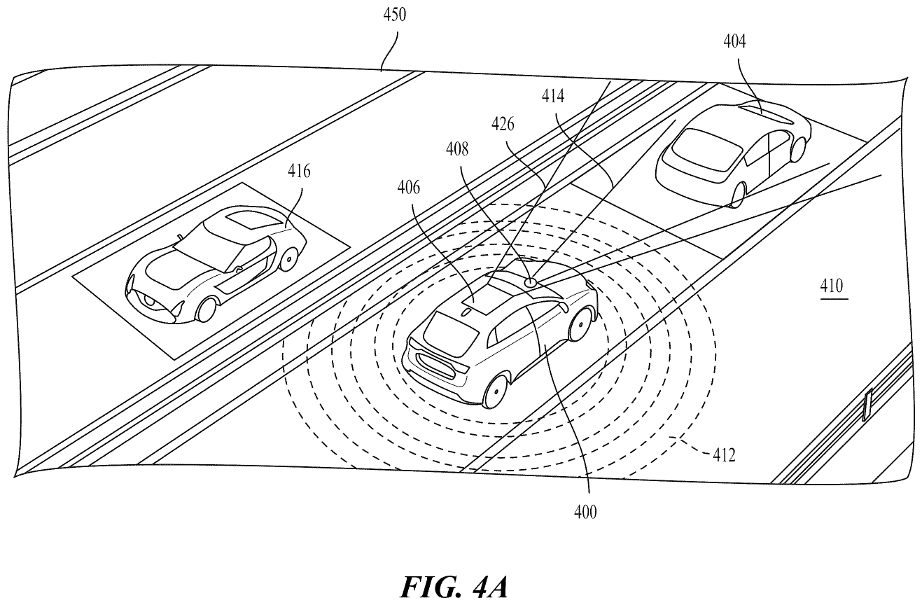

FIGS. 4A and 4B are block diagrams illustrating a vehicle configured with an out of sequence measurement (OOSM) vehicle state estimation system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and a gyroscopic sensor 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The gyroscopic sensor 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

As noted above, estimating a vehicle state of the vehicle 400 is a problem that is at the core of autonomous driving (AD) and autonomous racing (AR) technologies. In practice, a vehicle state is estimated by fusing available information from various sensing modalities into an estimate of the vehicle state. Unfortunately, fusing available information from various sensing modalities of the vehicle 400 may involve less reliable sensory information. In certain cases, vehicle measurements are received some time after they are sampled; however, these vehicle measurements are specified for instant processing to generate an estimate of the underlying state of the vehicle 400. For example, the reliability of global navigation satellite system (GNSS) information may vary in time. Additionally, performing sensor fusion as well as optical flow becomes less reliable as noise increases during changing lighting conditions. Additionally, estimating this reliability is imperative for determining noise statistics of a vehicle state estimation model.

Although out of sequence measurement (OOSM) processing is a well-studied problem, a sufficient OOSM solution for filters that jointly estimate the state and noise covariance in a variational Kalman filtering framework remains elusive. Conventional variational filtering solutions maintain a buffer of measurements and reprocess the measurements in the buffer each time an estimate is requested, or a new measurement is added to the buffer. Although conventional variational filtering solutions are sufficient from the vantage point of estimation accuracy, as variational methods employ fixed-point iterations in the measurement update, it becomes computationally costly to perform multiple measurement updates per time step.

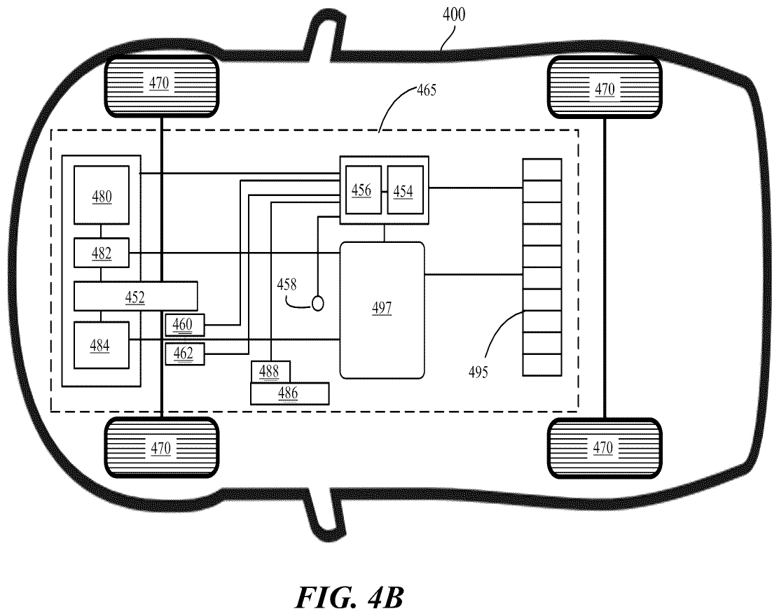

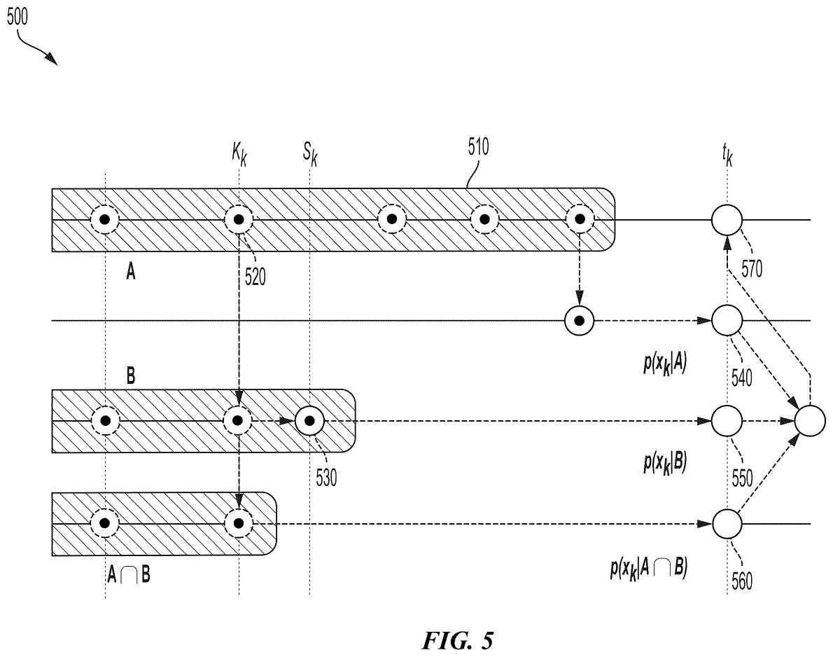

FIG. 5 illustrates a forward prediction combined with fusion and decorrelation (FPFD) process 500 for fusing various sensing modalities into a description of the vehicle state, according to various aspects of the present disclosure. As shown in FIG. 5, received measurements in a measurement buffer 510 are partitioned into three separate sets. Once partitioned, these three separate sets are predicted forward in time from various past checkpoints, before fusing them into an approximate filtering posterior.

As shown in FIG. 5, the three sets are “A,” “B,” and “C,” which contain the intersection of A and B. A current estimate 520 at a time k−1 is computed using the measurement set A and predicted forward to a time k (tₖ) to provide a first particle 540. An out of sequence measurement (OOSM) 530 arriving at a time k (kₖ) is sampled at some previous time s (sₖ), and the current estimate 520 is branched-off at the time kappa (kₖ), producing two additional particles, both computed with the measurements C=A∩B. A second particle 550 is predicted forward to the time k using the measurements B, and a third particle 560 is predicted forward to the time k using the measurements C. According to various aspects of the present disclosure, a fusion 570 of the three particles is performed at the time k, in which the information in C is subtracted from the information in B, before being added to A. In some implementations, subtracting information associated with the third particle 560 from the second particle 550 is performed prior to adding a difference to the first particle 540.

As shown in FIG. 5, various aspects of the present disclosure gauge the impact that the OOSM 530 has on the current estimate 520 (e.g., both state and noise covariance). In some implementations, two tracklets (e.g., the second particle 550 and the third particle 560) are branched off prior to a sample time of the OOSM 530, followed by predicting one tracklet forward with the OOSM 530 (e.g., the second particle 550) and predicting one tracklet (e.g., the third particle 560) without the OOSM 530. By leveraging an assumption of conditional independence, various aspects of the present disclosure quantify the information added by the OOSM 530 by processing these two tracklets and fusing them together with a first tracklet (e.g., the first particle 540) to produce a marginal filtering posterior as the fusion 570. In some implementations, an OOSM method is information lossless, exact in the linear setting, and extended to a nonlinear setting. In particular, instead of processing all the measurements in a buffer (as done when reprocessing) a single measurement is processed, which reduces the computational load of the filter. This mathematically motivated derivation forward prediction combined with a fusion and decorrelation (FPFD) scheme constitutes part of the OOSM vehicle state estimation system. In the following, this is described in more detail with various exemplars, as follows.

Various aspects of the present disclosure consider the problem of variational Bayes Kalman filtering (VB-KF) with out of sequence measurements (OOSMs) and generalize a standard OOSM method for linear Kalman filtering to the VB-KF setting. In some implementations, at the cost of introducing a memory buffer, the method produces near identical results to in-sequence processing but removes the need for more computationally heavy re-processing of measurements. Furthermore, the method is implementable for a wide range of VB-KF algorithms, including free-form approximations of the posterior distributions with factors of Gaussian, Inverse-Wishart, and Inverse-Gamma densities. Compared to re-ordering and reprocessing, significant improvements are shown in computational time at a minimal increase in mean-square error (MSE), making methods such as the VB-KFs viable for OOSM processing.

### I. Introduction

Kalman filtering (KF) and its various nonlinear extensions are indispensable tools in modern control theory. Recently, there has been a resurgence of interest in the Variational Bayes (VB) filtering methods. Such methods have great practical utility, as they adapt the noise statistics of the estimation model using light-weight iterative schemes. This endows the filter with robustness to modeling errors, and generally improves the estimated accuracy and consistency. Consequently, VB-KFs have been proposed as robust alternatives to KFs for automotive and underwater vehicle sensor fusion. In such applications, measurements are not always received instantaneously when they are sampled, necessitating out of sequence measurement (OOSM) techniques. Nevertheless, the application of classical methods for KFs, such as retrodiction techniques and forward prediction combined with fusion and de-correlation (FPFD) using tracklets have not been considered for the VB-KFs. Deriving such OOSM schemes is the principal objective of the present disclosure. In the most general setting, an estimation model is considered in the form:

$${x}_{k} ∼ p ( {x}_{k} \vert {x}_{k - 1} ) , \qquad ( 1 a )$$

$${\sum }_{{k}^{∼}} p ( {\sum }_{k} \vert {\sum }_{k - 1} ) , \qquad ( 1 b )$$

$${y}_{k} ∼ N ( {y}_{k} \vert {h}_{k} ( {x}_{k} ) , {\sum }_{k} ) , \qquad ( 1 c )$$

with states xₖ ∈ [symbol] ₘ, measurements yₖ ∈ [symbol] ^{d}, and where Σₖ ∈ [symbol] ^{d×d} is the covariance matrix of the measurement model. The measurement model is assumed to be Gaussian, and the mean of the measurement is a nonlinear in the states.

If the measurement noise covariance matrix Σₖ is known and the estimation model (1) is Gaussian and linear in the states, the problem of estimating xₖ from a sequence of measurements y_{0:k}={y₀, . . . ,yₖ} is solved, and the minimum mean square error (MMSE) estimator is the KF. When Σₖ is not known, a marginal filtering posterior p(xₖ, Σₖ|y_{0:k})≈q(xₖ,Σₖ) is approximated using the VB-KF framework. For this purpose, it is common to define the target density q as products of Gaussian, Inverse-Gamma, and Inverse-Wishart densities. That is, various implementations have computed p(xₖ, Σₖ|y_{0:k}\{yₛ})≈q⁻(xₖ, Σₖ) for some s∈(0,k)⊂ [symbol] and then receive OOSM yₛ at a time k. How to incorporate yₛ and approximate p(xₖ, Σₖ|y_{0:k}) from p(xₖ, Σₖ|y_{0:k}{yₛ}) remains an open problem in the context of VB-KFs.

Various aspects of the present disclosure propose an OOSM method for VB-KFs based on the FPFD algorithm and generalize it beyond its original confinement to Gaussian posteriors. The proposed method can be used with variational families including products of Gaussian and Inverse-Wishart densities, where the proposed method retains computational performance when incorporating the OOSMs.

[symbol]

Vectors are denoted by x∈ [symbol] ⁿ, with [x]ᵢ being the i^{th} element of x. Matrices are indicated in as an italics X, and the element on row i and column j of X is [X]ᵢⱼ.

$$X ∈ {𝕊}_{+ +}^{n}$$

indicates that X∈ [symbol] ^{n×n} and positive definite. The notation

$$\underline{x} ∼ N ( x \vert m , P ) ∝ {\vert P \vert}^{- 1 / 2} exp ( - \frac{1}{2} ( x - m ) {P}^{- 1} ( x - m ) ) ,$$

indicates that x∈ [symbol] ^{m} is Gaussian distributed with mean m∈ [symbol] ^{m} and covariance P∈ [symbol] ^{m×m}. Analogously

$$let \underline{Σ} ∼ IW ( Σ \vert v , V ) ∝ {\vert Σ \vert}^{- ( v + n + 1 ) / 2} exp ( - \frac{1}{2} Tr ( V {Σ}^{- 1} ) ) ,$$

indicate that

$$\underline{Σ} ∈ {𝕊}_{+ +}^{d}$$

is Inverse-Wishart (IW) distributed with v degrees of freedom, scale matrix

$$V ∈ {𝕊}_{+ +}^{d} ,$$

and where Tr(⋅) is the trace operator. The expectation of x~pₓ(x) as [symbol] _{x~p}_{_{\vec{x}}}₍ₓ₎ [x]=∫xp(x)dx is written compactly as [symbol] ₚ[x]. In this notation, the KL-divergence between two density functions p and q is KL(p∥q)= [symbol] ₚ[log(p(x)/q(x))].

A measurement (yₖ, sₖ, tₖ) is defined by data yₖ∈ [symbol] ^{d} measured at a time sₖ ∈ [symbol] and received at a time tₖ≥sₖ. Ideally, the measurement is in-sequence, so that sₖ=tₖ. The set of such in-sequence measurements (ISMs) is defined as:

$${y}_{k}^{ISM} = \{ ( {y}_{i} , {s}_{i} , {t}_{i} ) \vert {s}_{i} = {t}_{i} , i \leq k \} . \qquad ( 2 )$$

However, due to delays, some measurements may be received at a later time, so that sₖ<tₖ at the time step k. The set of such out of sequence measurements (OOSMs) is defined as:

$${y}_{k}^{O O S M} = \{ ( {y}_{i} , {s}_{i} , {t}_{i} ) \vert {s}_{i} < {t}_{i} , i \leq k \} . \qquad ( 3 )$$

The set of all measurements at a time step k is defined as:

$${y}_{k} = {y}_{k}^{ISM} ⋃ {y}_{k}^{O O S M} ) . \qquad ( 4 )$$

As the main computational burden in VB-KFs is in the variational updates, various aspects of the present disclosure focus on methods that minimize the number of such updates required to process the OOSMs. Furthermore, a method that closely approximates the reordering and reprocessing is desired, as this is the optimal solution in the linear setting given unlimited compute and memory.

Known results on linear KF and VB-KF theory are stated in Sec. II and review various OOSM methods that assume known noise statistics in Sec. III. New extensions of the FPFD method to VB-KFs with unknown noise statistics are presented in Sec. IV. The algorithm is demonstrated using numerical examples in Sec. V and conclude in Sec. VI.

### II. Preliminaries

The KFs and VB-KFs are trivially extended to the nonlinear setting, but to clarify the presentation, the methods are presented with a linear Gaussian estimation model:

$${x}_{k} ∼ N ( {x}_{k} \vert {A}_{k - 1} {x}_{k - 1} , {Q}_{k - 1} ) , \qquad ( 5 a )$$

$${y}_{k} ∼ N ( {y}_{k} \vert {C}_{k} {x}_{k - 1} , {\sum }_{k} ) . \qquad ( 5 b )$$

If the measurements are ISM (sₖ=tₖ), the noise covariance matrices Σ_{0:k} are known, the model is given by (5), and the prior p(x₀)=N(x₀|m_{0|-1}, P_{0|-1}) is Gaussian, then the minimum mean square error (MMSE) estimator is the KF. The filtering posterior is expressed as p(xₖ|y_{0:k})=N(xₖ|Mₖ,Pₖ) and this is characterized exactly by a recursion involving prediction:

$${m}_{k \vert k - 1} = {A}_{k - 1} {m}_{k - 1} , \qquad ( 6 a )$$

$${P}_{k \vert k - 1} = {A}_{k - 1} {P}_{k - 1} {A}_{k - 1} + {Q}_{k - 1} , \qquad ( 6 b )$$

followed by a measurement update:

$${S}_{k} = {C}_{k} {P}_{k \vert k - 1} {C}_{k}^{T} + {R}_{k} \qquad ( 7 a )$$

$${K}_{k} = {P}_{k \vert k - 1} {C}_{k}^{T} {S}_{k}^{- 1} \qquad ( 7 b )$$

$${m}_{k} = {m}_{k \vert k - 1} + {K}_{k} ( {y}_{k} - {C}_{k} {m}_{\vert k - 1} ) \qquad ( 7 c )$$

$${P}_{k} = {P}_{k \vert k - 1} - {K}_{k} {S}_{k} {K}_{k}^{T} . \qquad ( 7 d )$$

If making the same assumptions but forgoing the knowledge of the measurement noise sequence Σ_{0:k}, several methods can be employed to jointly estimate the state and the noise statistics. Various aspects of the present disclosure focus on a Variational Bayes method, which assumes a free-form factorization of the filter posterior:

$$p ( {x}_{k} , {Σ}_{k} \vert {y}_{0 : k} ) \approx {q}_{x} ( {x}_{k} ) {q}_{Σ} ( {Σ}_{k} ) , \qquad ( 8 )$$

and approximates it by minimizing the KL-divergence:

$$arg {min}_{{q}_{x} , {q}_{Σ}} KL ( {q}_{x} ( {x}_{k} ) {q}_{Σ} ( {Σ}_{k} ) \vert \vert p ( {x}_{k} , {Σ}_{k} \vert {y}_{0 : k} ) ) . \qquad ( 9 )$$

From variational calculus, the minimizers to (9) satisfy:

$${q}_{x} ( {x}_{k} ) ∝ exp ( {𝔼}_{q Σ} [ log ( p ( {x}_{k} , {Σ}_{k} \vert {y}_{0 : k} ) ) ] ) , \qquad ( 10 a )$$

$${q}_{Σ} ( {Σ}_{k} ) ∝ exp ( {𝔼}_{q x} [ log ( p ( {x}_{k} , {Σ}_{k} \vert {y}_{0 : k} ) ) ] ) . \qquad ( 10 b )$$

Several different VB-KFs can be derived based on the choice of the variational family, but a common choice is to let qₓ(xₖ)=N(xₖ|mₖ,Pₖ) and q_{Σ}(Σₖ)=IW (Σₖ|Vₖ,Vₖ). This is due to the Gaussian being its own conjugate prior, and the IW being the conjugate prior for the covariance matrix of a multivariate normal distribution, modeled in (1c) and (5b). Various aspects of the present disclosure summarize the VB-KF in brevity, deviating only in the covariance prediction model.

The prediction of the Gaussian density is computed through the Chapman-Kolmogorov equation, yielding a KF prediction. The IW-prediction is defined, and Equations (1a) and (1b) are independent, if p(xₖ₋₁,Σₖ₋₁|y_{0:k-1})qₓ(xₖ₋₁)q_{Σ}(Σₖ₋₁),

$$p ( {x}_{k} , {Σ}_{k} \vert {y}_{0 : k - 1} ) = p ( {x}_{k} \vert {y}_{0 : k - 1} ) p ( {Σ}_{k} \vert {y}_{0 : k - 1} ) , \qquad ( 11 )$$

$$where : p ( {x}_{k} \vert {y}_{0 : k - 1} ) = N ( {x}_{k} \vert {m}_{k \vert k - 1} , {P}_{k \vert k - 1} ) , \qquad ( 12 )$$

$$p ( {Σ}_{k} \vert {y}_{0 : k - 1} ) = IW ( {Σ}_{k} \vert {v}_{k \vert k - 1} , {V}_{k \vert k - 1} ) . \qquad ( 13 )$$

In this example, the IW-prediction is expressed in hₖ=tₖ₊₁−tₖ. By defining a first-order ODE in the IW statistics with a time-constraint τ, and discretizing this by zero-order-hold, the prediction step is obtained:

$${m}_{k \vert k - 1} = {A}_{k - 1} {m}_{k - 1} , \qquad ( 14 a )$$

$${P}_{k \vert k - 1} = {A}_{k - 1} {P}_{k - 1} {A}_{k - 1} + {Q}_{k - 1} , \qquad 14 b )$$

$${v}_{k \vert k - 1} = {a}_{k} {v}_{k - 1} + {b}_{k} ( d + 1 ) , \qquad ( 14 c )$$

$${V}_{k \vert k - 1} = {a}_{k} {V}_{k - 1} , \qquad ( 14 d )$$

$${a}_{k} = exp ( - {h}_{k} {τ}^{- 1} ) , \qquad ( 14 e )$$

$${b}_{k} = exp ( - {h}_{k} {τ}^{- 1} ) ( exp ( {h}_{k} {τ}^{- 1} ) - 1 ) , \qquad ( 14 f )$$

Here, τ is a time constraint akin to a forgetting factor in recursive least squares, resulting in a prediction model capable of supporting variable-rate sampling, as is necessary when later considering OOSMs with variable and a priori unknown measurement delays.

Given this particular choice of variational family, the measurement update is similar to the KF update (7), with

$${S}_{k} = {C}_{k} {P}_{k \vert k - 1} {C}_{k}^{T} + {( {v}_{k} - d - 1 )}^{- 1} {V}_{k} , \qquad ( 15 a )$$

$${K}_{k} = {P}_{k \vert k - 1} + {C}_{k}^{T} {S}_{k}^{- 1} , \qquad ( 15 b )$$

$${m}_{k} = {m}_{k \vert k - 1} + {K}_{k} ( {y}_{k} - {C}_{k} {m}_{k \vert k - 1} ) , \qquad ( 15 c )$$

$${P}_{k} = {P}_{k \vert k - 1} - {K}_{k} {S}_{k} {K}_{k}^{T} , \qquad ( 15 d )$$

over the Gaussian parameters, and

$${v}_{k} = {v}_{k \vert k - 1} + 1 \qquad ( 15 e )$$

$${V}_{k} = {V}_{k \vert k - 1} + {C}_{k} {P}_{k} {C}_{k}^{T} + ( {y}_{k} - {C}_{k} {m}_{k} ) {( ⋆ )}^{T} , \qquad ( 15 f )$$

over the IW parameters. In practice, these seemingly intractable equations are solved efficiently by fixed-point iterations, which come with guarantees on weak monotonic convergence in the KL-divergence over the iterates. This allows a predicted density to be updated with yₖ, yielding:

$$p ( {x}_{k} , {Σ}_{k} \vert {y}_{0 : k} ) \approx N ( {x}_{k} \vert {m}_{k} , {P}_{k} ) IW ( {Σ}_{k} \vert {v}_{k} , {V}_{k} ) . \qquad ( 16 )$$

Using the fixed-point iterations and the nonlinear extensions of the VB-KF, various aspects of the present disclosure show generalizing the OOSM methods for KFs to VB-KFs is possible by imposing minor restrictions on the variational family.

### III. OOSM with Known Noise Statistics

Next, handling OOSMs using VB-KFs is discussed. These methods rely on a set of standard assumptions, here restated for clarity:

The OOSM time delay is uniformly bounded:

$${sup}_{k ∈ ℕ} {t}_{k} - {s}_{k} \leq {t}^{+} , \qquad ( 17 )$$

for any measurement (yₖ, sₖ, tₖ), the upper bound on the maximum delay t⁺>0 is known.

The filter prior is non-generate:

$${P}_{0 \vert - 1} ∈ {𝕊}_{+ +}^{n}$$

in the context of the Gaussian posteriors of the KF in Sec. II. Additionally,

$${V}_{0 \vert - 1} ∈ {𝕊}_{+ +}^{d} and {ν}_{0 \vert - 1} > d + 1$$

in the context of the IW-components of the VB-KF in Sec. II.

The uniform bounding assumption regarding Equation (17) implies that the OOSMs need only be considered over t∈[tₖ−t⁺, tₖ], making reprocessing feasible and bounding the size of buffers in the FPFD methods. Assumption regarding the filter prior ensures that the problem is well posed.

In the linear Gaussian setting (5), the optimal solution to the OOSM problem is to re-order the measurements in accordance with their sample time, and re-compute the filtering posterior sequentially. In practice, this is done using measurement and estimate buffers. By the uniform bounding assumption, measurements received before tₖ−t⁺ can be processed as interstellar mediums (ISMs). Thus, a set of “committed” measurements is defined:

$${y}_{k}^{c} = \{ ( y ( {s}_{i} ) , {s}_{i} , {t}_{i} ) \vert {s}_{i} < {t}_{k} - {t}^{+} , i ∈ ℕ \} , \qquad ( 18 )$$

and a second set that is maintained in a measurement buffer:

$${y}_{k}^{b} = {y}_{k} ∖ {y}_{k}^{c} . \qquad ( 19 )$$

Given a known bound

$${t}^{+} , p ( {x}_{k} \vert {y}_{k}^{c} )$$

is maintained in memory at tₖ. The measurements are sorted by sample times in a buffer and processed in sequence to compute p(xₖ|yₖ).

This method stores the statistics of

$$p ( {x}_{k} \vert {y}_{k}^{c} )$$

and processes

$$\vert {y}_{k}^{b} \vert$$

measurement updates each time an OOSM is received, resulting in a significant computational burden.

As optimal reprocessing is computationally demanding, a convenient FPFD method is considered. This method propagates two tracklets, removes any redundant information, and fuses them with the original track at the time tₖ. In the following, this method is expressed in generic densities to facilitate its extensions to VB-KFs in Sec. IV.

Assume that there is an OOSM (yₖ, sₖ, tₖ) that is sampled at sₖ<tₖ, but received at a time tₖ. A previously processed measurement some time prior to sₖ is:

$${u}_{k} = max \{ {s}_{i} \vert {s}_{i} < {s}_{k} , ( {y}_{i} , {s}_{i} , {t}_{i} ) ∈ {y}_{k - 1} \} , \qquad ( 20 )$$

and define a set:

$$\underline{y} ( {u}_{k} ) = \{ ( {y}_{i} , {s}_{i} , {t}_{i} ) ∈ {y}_{k - 1} \vert {s}_{i} < {u}_{k} \} . \qquad ( 21 )$$

The measurements are subsequently partitioned into two sets, temporarily dropping the time index for clarity: A≙yₖ₋₁ and B≙y(uₖ)∪(yₖ, sₖ,tₖ). The FPFD method can then be interpreted as fusing the tracks at tₖ by the heuristic:

$$p ( {x}_{k} \vert A ⋃ B ) = ∝ \frac{p ( {x}_{k} \vert A ) p ( {x}_{k} \vert B )}{p ( {x}_{k} \vert A ⋂ B )} , \qquad ( 22 )$$

where ∝ is a normalizing constant. This provides an intuitive approach for including the OOSM: the common information is subtracted, resulting from y(uₖ)=A∩B before fusing the information of A and B to avoid “double counting” the measurements in this intersection.

This interpretation of FPFD elucidates its strong connections to decentralized data fusion. Notably, this fusion is only optimal if A≙A\{A∩B} and B≙B\{A∩B} are conditionally independent given xₖ [16, Lemma 4]. If implemented as in (22) for a Markovian system, there are cases in which this holds, referred to as the 1-step lag case. For the multi-step case, the information Cov[A,B|xₖ] is disregarded in the fusion. Notably, FPFD is suboptimal but approaches the optimal solution if Qₖ→0 for all k, where then Cov[A,B|xₖ]→0.

Despite being suboptimal, the FPFD method is appealing due to its computational properties. If the densities in (22) are Gaussian, characterized to p(xₖ|A∪B) using the KF recursions (6)-(7). By computing:

$$p ( {x}_{k} \vert A ) = N ( {x}_{k} \vert {m}_{k}^{A} , {P}_{k}^{A} ) , \qquad ( 23 a )$$

$$p ( {x}_{k} \vert B ) = N ( {x}_{k} \vert {m}_{k}^{B} , {P}_{k}^{B} ) , \qquad ( 23 b )$$

$$p ( {x}_{k} A ⋂ B ) = N ( {x}_{k} \vert {m}_{k}^{A ⋂ B} , {P}_{k}^{A ⋂ B} ) , \qquad ( 23 c )$$

the posterior p(xₖ|yₖ) can be expressed approximately in:

$$\{ {m}_{k}^{A} , {P}_{k}^{A} , {m}_{k}^{B} , {P}_{k}^{B} , {m}_{k}^{A ⋂ B} , {P}_{k}^{A ⋂ B} \}$$

by implementing (22).

An efficient implementation of the FPFD method necessitates a buffer, but unlike the buffer of measurements in Sec. III, a buffer of densities is specified. Given uniform bounding assumption and Equation (18), this buffer is specified to a length as long as the maximum number of measurements that can possibly be sampled on this interval number of measurements. Instead of performing as many measurement updates when a new OOSM is received as in the optimal re-processing solution, one measurement update and application Equation (22) are performed.

FPFD is presented for Gaussian densities, but as the underlying fusion rule (22) is independent of the exact form of the posterior, FPFD is generalized to the free-form posteriors of the variational Bayes methods. The resulting method is sketched conceptually in FIG. 5, and the only difference from the conventional FPFD method is the parameterization of the posterior and implementation of (22).

### IV. OOSM with Unknown Noise Statistics

When the measurement noise statistics of (1c) are unknown and estimated by VB-KFs, a simple solution to dealing with OOSMs is to follow Sec. III-A and reprocess the measurements. However, as the measurement updates are fixed-point iterations, processing OOSMs in this manner incurs an even greater instantaneous computational burden than in the usual KF setting (see Remark 1). As (22) is expressed in densities that are computable with the VB-KF, it is possible to generalize FPFD to other variational families. For example, considering a VB-KF, and reusing the measurement sets in Sec. III, (22) may be implemented with:

$$p ( {x}_{k} , {Σ}_{k} \vert A ) = N ( {x}_{k} \vert {m}_{k}^{A} , {P}_{k}^{A} ) IW ( {Σ}_{k} \vert {v}_{k}^{A} , {V}_{k}^{A} ) , \qquad ( 24 a )$$

$$p ( {x}_{k} , {Σ}_{k} \vert B ) = N ( {x}_{k} \vert {m}_{k}^{B} , {P}_{k}^{B} ) IW ( {Σ}_{k} \vert {v}_{k}^{B} , {V}_{k}^{B} ) , \qquad ( 24 b )$$

$$p ( {x}_{k} , {Σ}_{k} \vert C ) = N ( {x}_{k} \vert {m}_{k}^{C} , {P}_{k}^{C} ) IW ( {Σ}_{k} \vert {v}_{k}^{C} , {V}_{k}^{C} ) , \qquad ( 24 c )$$

where C=A∩B to simplify the notation. The product and ratios of Gaussian densities is an un-normalized Gaussian, and the same is true for IWs. To make the exposition clear and generalize the FPFD beyond the Gaussian-Inverse-Wishart setting, the fusion in terms of a KL-divergence are considered. Specifically, an optimization problem is posed:

$$arg {min}_{{q}_{x} , {q}_{Σ}} KL ( {q}_{x} ( {x}_{k} ) {q}_{Σ} ( {Σ}_{k} ) \vert \vert ∝ \frac{p ( {x}_{k} , {Σ}_{k} \vert A ) p ( {x}_{k} , {Σ}_{k} \vert B )}{p ( {x}_{k} , {Σ}_{k} \vert C )} ) , \qquad ( 25 )$$

where ∝>0 is a normalizing constant. Given the free-form factorization of the Gaussian-Inverse-Wishart VB-KF, this problem is reformulated as:

$$arg {min}_{{q}_{x} , {q}_{Σ}} KL ( {q}_{x} ( {x}_{k} ) {q}_{Σ} ( {Σ}_{k} ) \vert \vert {\overline{p}}_{x} ( {x}_{k} ) {\overline{p}}_{Σ} ( {Σ}_{k} ) ) , \qquad ( 26 )$$

$$Where : {\underline{p}}_{x} ( {x}_{k} ) {=}^{Δ} {∝}_{x} \frac{N ( {x}_{k} \vert {m}_{k}^{A} , {P}_{k}^{A} ) N ( {x}_{k} \vert {m}_{k}^{B} , {P}_{k}^{B} )}{N ( {x}_{k} \vert {m}_{k}^{C} , {P}_{k}^{C} )} , \qquad ( 27 a )$$

$${\underline{p}}_{Σ} ( {Σ}_{k} ) {=}^{Δ} {∝}_{Σ} \frac{IW ( {Σ}_{k} \vert {v}_{k}^{A} , {V}_{k}^{A} ) IW ( {Σ}_{k} \vert {v}_{k}^{B} , {V}_{k}^{B} )}{IW ( {Σ}_{k} \vert {v}_{k}^{C} , {V}_{k}^{C} )} , \qquad ( 27 b )$$

and ∝ₓ, ∝_{Σ}>0 are normalizing constants. Here,

$$K L ( {q}_{x} ( {x}_{k} ) {q}_{Σ} ( {Σ}_{k} ) \vert \vert {\overline{p}}_{x} ( {x}_{k} ) {\overline{p}}_{Σ} ( {Σ}_{k} ) ) = \int \int {q}_{x} ( {x}_{k} ) {q}_{Σ} ( {Σ}_{k} ) log ( \frac{{q}_{x} ( {x}_{k} ) {q}_{Σ} ( {Σ}_{k} )}{{\overline{p}}_{x} ( {x}_{k} ) {\overline{p}}_{Σ} ( {Σ}_{k} )} ) d {x}_{k} d {Σ}_{k} \qquad ( 28 a )$$

$$= {E}_{{q}_{x}} [ log ( \frac{{q}_{x} ( {x}_{k} )}{{\underline{p}}_{x} ( {x}_{k} )} ) ] {E}_{q Σ} [ 1 ] + {E}_{q x} [ 1 ] {E}_{q Σ} [ log ( \frac{{q}_{Σ} ( {Σ}_{k} )}{{\underline{p}}_{Σ} ( {Σ}_{k} )} ) ] = KL ( {q}_{x} ( {x}_{k} ) \vert \vert {\underline{p}}_{x} ( {x}_{k} ) ) + KL ( {q}_{Σ} ( {Σ}_{k} ) \vert \vert {\underline{p}}_{Σ} ( {Σ}_{k} ) ) . \qquad ( 28 b )$$

As such, the two components of the cost are treated entirely separately. Such a decomposition of the KL-divergences can be done for any free-form factorization of the posterior. The terms of the cost are treated independently as follows.

The optimal solution to the problem

$$arg {min}_{{q}_{x}} ( {q}_{x} ( {x}_{k} ) \vert \vert {\underline{p}}_{x} ( {x}_{k} ) ) , \qquad ( 29 )$$

is qₓ(xₖ)=N(xₖ|mₖ,Pₖ) with parameters:

$${m}_{k} = {P}_{k} [ {( {P}_{k}^{A} )}^{- 1} {m}_{k}^{A} + {( {P}_{k}^{B} )}^{- 1} {m}_{k}^{B} - {( {P}_{k}^{C} )}^{- 1} {m}_{k}^{C} ] \qquad ( 30 )$$

$${P}_{k} = {[ {( {P}_{k}^{A} )}^{- 1} + {( {P}_{k}^{B} )}^{- 1} - {( {P}_{k}^{C} )}^{- 1} ]}^{- 1}$$

and at the optimal solution, KL(qₓ(xₖ)∥pₓ(xₖ))=0.

The optimal solution to the problem

$$arg {min}_{{q}_{Σ}} KL ( {q}_{Σ} ( {Σ}_{k} ) \vert \vert {\overline{p}}_{Σ} ( {Σ}_{k} ) ) , \qquad ( 31 )$$

is q_{Σ}(Σₖ)=IW(Σₖ|vₖ,Vₖ), with parameters:

$${V}_{k} = {V}_{k}^{A} + {V}_{k}^{B} - {V}_{k}^{C} , \qquad ( 32 a )$$

$${v}_{k} = {v}_{k}^{A} + {v}_{k}^{B} - {v}_{k}^{C} , \qquad ( 32 b )$$

and at the optimal solution, KL(q_{Σ}(Σₖ)∥p_{Σ}(Σₖ))=0.

As the components of the KL divergence (28b) are zero at the optima, an FPFD OOSM method implementing Proposition 1 and 2 produces the same results as in sequence measurement processing when (15) is exact. In the linear setting, this holds under the same conditions as the original FPFD. In a nonlinear setting, discrepancies between re-ordering and ISM and the FPFD method are possible due to the approximations involved in predicting the individual components that enter the fusion rule. The resulting algorithm is implemented with an estimate buffer, defined as:

$${B}_{k} = \{ ( p ( {x}_{i} , {Σ}_{i} \vert {y}_{i} ) , {t}_{i} ) \vert {t}_{i} ∈ [ {t}_{k} - {t}^{+} , {t}_{k} ] , ( \cdot , \cdot , {t}_{i} ) ∈ {y}_{k} \} .$$

Similar to the original FPFD algorithm, the length of this buffer may vary in time but will be of the same length as a measurement buffer in the in-sequence processing solution. The buffer update is sketched in Algorithm 1, executed every time a new measurement is received. The most recent element in the buffer is used to compute an estimate at each time tₖ. In the case of Gaussian-Inverse-Wishart VB-KFs, the minimum MSE estimate is output, which takes the form:

$${\hat{x}}_{k} = {E}_{p ( {x}_{k} , {Σ}_{k} \vert {y}_{k} )} [ {\underline{x}}_{k} ] = {m}_{k} , \qquad ( 33 a )$$

$${\hat{Σ}}_{k} = {E}_{p ( {x}_{k} , {Σ}_{k} \vert {y}_{k} )} [ {\underline{Σ}}_{k} ] = {( {v}_{k} - d - 1 )}^{- 1} {V}_{k} . \qquad ( 33 b )$$

Algorithm 1 The FPFD buffer update for VB-KFs.

| | | |
|---|---|---|
| 1: | receive (yₖ, sₖ, tₖ) and estimate buffer [symbol] ₖ₋₁. | |
| 2: | Find time of nearest estimate in the buffer uₖ | (20) |
| 3: | if sₖ = tₓ then | |
| 4: | Retrieve p(x(tₖ₋₁), Σ(tₖ₋₁)\|A) from [symbol] ₖ₋₁ | |
| | // Regular VB-KF prediction update | |
| 5: | p(x(tk), Σ(tₖ)\|A) ← p(x(tₖ₋₁), Σ(tₖ₋₁)\|A) | (14) |
| 6: | p(xₖ, Σₖ\|yₖ) ← p(x(tₖ), Σ(tₖ)\|A) | (15) |
| 7: | else | |
| 8: | Retrieve p(x(tₖ₋₁), Σ(tₖ₋₁)\|A) from [symbol] ₖ₋₁ | |
| 9: | Retrieve p(x(uₖ), Σ(uₖ)\|C) from [symbol] ₖ₋₁ | |
| | // Update track associated with the set A | |
| 10: | p(x(tₖ), Σ(tₖ)\|A) ← p(x(tₖ₋₁), Σ(tₖ₋₁)\|A) | (14) |
| | // Update track associated with the set B | |
| 11: | p(x(sₖ), Σ(sₖ)\|C) ← p(x(uₖ), Σ(uₖ)\|C) | (14) |
| 12: | p(x(sₖ), Σ(sₖ)\|B) ← p(x(sₖ), Σ(sₖ)\|C) | (15) |
| 13: | p(x(tₖ), Σ(tₖ) \|B) ← p(x(sₖ), Σ(sₖ)\|B) | (14) |
| | // Update track associated with the set C = A ∩ B | |
| 14: | p(x(tₖ), Σ(tₖ)\|C) ← p(x(uₖ), Σ(uₖ)\|C) | (14) |
| | // Fuse tracks with parameters of p(x(tₖ), Σ(tₖ)\| ·) | |
| 15: | $N ( {x}_{k} \vert {m}_{k} , {P}_{k} ) ← \{ {m}_{k}^{A} , {P}_{k}^{A} , {m}_{k}^{B} , {P}_{k}^{B} , {m}_{k}^{C} , {P}_{k}^{C} \}$ | (30) |
| 16 | $IW ( {\sum }_{k} \vert {v}_{k} , {V}_{k} ) ← \{ {v}_{k}^{A} , {V}_{k}^{A} , {v}_{k}^{B} , {V}_{k}^{B} , {v}_{k}^{C} , {V}_{k}^{C} \}$ | (32) |
| | // Form posterior | |
| 17 | p(xₖ, Σ_{k\|}yₖ) = N(xₖImₖ, Pₖ)IW(Σ_{k\|}vₖ,Vₖ) | |
| 18: | end if | |
| 19: | Update buffer [symbol] ₖ ← [symbol] ₖ₋₁ ∪ [(p(xₖ, Σₖ\|yₖ), tₖ)} | |
| 20: | Prune [symbol] ₖ, removing elements associated with s < tₖ − t⁺ | |
| 21: | return Updated estimate buffer [symbol] ₖ | |

It is noted that if the VB-KF free-form factorization (8) is comprised of densities qᵢ(zᵢ) of distributions Qᵢ, with a posterior Πᵢ qᵢ(zᵢ), such that:
multiplying qᵢ(zᵢ) with a density function of Qᵢ is proportional to a density function of Qᵢ; and that
Dividing qᵢ(zᵢ) with density function of Qᵢ is proportional to some density function of Qᵢ,
   then the FPFD OOSM algorithm is implementable for the VB-KF. This encompasses many other variational families, products of Inverse-Gamma distributions over diagonal elements of the noise variance matrix Σ.

Various aspects of the present disclosure demonstrate that the FPFD OOSM method for KFs can be extended to free-form factorized posterior with factors satisfying a set of permissible conditions. Such factors include Gaussian, Inverse-Wishart, and Inverse-Gamma densities, among many others. This insight has significant utility, as it permits simple algorithms for OOSM processing of VB-KFs, such as those with IW-densities or products of IG-densities. This serves as a practical purpose when deploying such algorithms under communication delays.

In some implementations of the OOSM vehicle estimation system, factors of Gaussian densities are used to define the variational family of the posterior. In this case, it is understood that the fusion rule can be expressed in the moments {m_{A}, P_{A}, m_{B}, P_{B}, m_{C}, P_{C}}, there is a constant ∝ₓ>0 and parameters {m_{D}, P_{D},} such that:

$$\frac{N ( x \vert {m}_{A} , {P}_{A} ) N ( x \vert {m}_{B} , {P}_{B} )}{N ( x \vert {m}_{C} , {P}_{C} )} = {∞}_{x}^{- 1} N ( x \vert {m}_{D} , {P}_{D} ) . \qquad ( 41 )$$

With x∈ [symbol] ^{m}, and plugging in

$$N ( x \vert m , P ) = f ( m , P ) exp ( - \frac{1}{2} {( x - m )}^{⊤} {P}^{- 1} ( x - m ) ) ,$$

with a normalizing constant f(m,P)=2^{-m/2} P|^{-1/2}. Completion of squares yields equality in (41) when:

$${P}_{D}^{- 1} = {P}_{A}^{- 1} + {P}_{B}^{- 1} - {P}_{C}^{- 1} , \qquad ( 42 a )$$

$${m}_{D} = {P}_{D} [ {P}_{A}^{- 1} {m}_{A} + {P}_{B}^{- 1} {m}_{B} - {P}_{C}^{- 1} {m}_{C} ] , \qquad ( 42 b )$$

$${∝}_{x} = \frac{f ( {m}_{A} , {P}_{A} ) f ( {m}_{B} , {P}_{B} )}{f ( {m}_{C} , {P}_{C} ) f ( {m}_{D} , {P}_{D} )} , \qquad ( 42 c )$$

where ∝ₓ is positive and well-defined when

$$P ∈ {𝕊}_{+ +}^{m} .$$

It follows that pₓ(x) is Gaussian, and therefore KL (N(x|m_{D}, P_{D})∥pₓ(x))=0 if defined with (42).

In some embodiments of the OOSM vehicle estimation system, factors of Inverse-Wishart densities are used to define the variational family of the posterior. It is understood that for the parameters constituting the three particles in the FPFD scheme {v_{A}, V_{A}, V_{B}, V_{B}, v_{C}, V_{C}}, there always exists a ∝_{Σ}>0 and parameters {v_{D}, V_{D},} such that:

$$\frac{IW ( Σ \vert {v}_{A} , {V}_{A} ) IW ( {Σ}_{k} \vert {v}_{B} , {V}_{B} )}{IW ( Σ \vert {v}_{C} , {V}_{C} )} = {∝}_{Σ}^{- 1} IW ( Σ \vert {v}_{D} , {V}_{D} ) \qquad ( 43 )$$

### With

$$Σ ∈ {𝕊}_{+ +}^{d} ,$$

and plugging in:

$$IW ( Σ \vert v , V ) = \frac{{2}^{- \frac{1}{2} ( v - d - 1 ) d} {\vert V \vert}^{\frac{1}{2} ( v - d - 1 )}}{{Γ}_{d} ( \frac{1}{2} ( v - d - 1 ) ) {Σ}^{\frac{1}{2} v}} exp ( - \frac{1}{2} T r ( {Σ}^{- 1} V ) ) \qquad ( 44 )$$

(43) holds with:

$${V}_{D} = {V}_{A} + {V}_{B} - {V}_{C} \qquad ( 45 a )$$

$${v}_{D} = {v}_{A} + {v}_{B} - {v}_{C} \qquad ( 45 b )$$

$${∝}_{Σ} = \frac{f ( {V}_{A} , {v}_{A} ) f ( {V}_{B} , {v}_{B} )}{f ( {V}_{C} , {v}_{C} ) f ( {V}_{D} , {v}_{D} )} \qquad 45 c )$$

$$Where :$$

$$f ( V , v ) = \frac{{2}^{- \frac{1}{2} ( v - d - 1 ) d} {\vert V \vert}^{\frac{1}{2} ( v - d - 1 )}}{{Γ}_{d} ( \frac{1}{2} ( v - d - 1 ) )} > 0 \qquad ( 46 )$$

when

$$v > d + 1 and V ∈ {S}_{+ +}^{d} .$$

It thus follows that p_{Σ}(Σ) is IW, and
KL(IW(Σ|v_{D},V_{D})∥p_{Σ}(Σ))=0 with (45).

In yet other implementations of the OOSM vehicle estimation system, factors of Inverse-Gamma densities are used to define the variational family of the posterior. As the Inverse-Wishart of one dimension is an Inverse-Gamma density, it is understood that the update of the parameters takes the form of (45).

It is understood that this implementation of the OOSM method obtains similar accuracy to the estimates as the state of the art, but at a fraction of the computation time. The OOSM method operating on a difficult target tracking benchmark from the literature exhibited a significant speedup (e.g., 2.5×) at no apparent loss in performance. In some implementations, the OOSM method is focused on driving technologies, in particular those performing late fusion of multiple sensing modalities, including but not limited to RADAR, LiDAR, GNSS, Optical Flow, Vision information, velocity information from a brake electronic control unit (ECU), and inertial measurement unit information. Additionally, examples of noise statistics that are uncertain or time varying include auxiliary measurements, such as road-geometry detection, the tracking of classical corner features, or any other information that may indicate the state of the vehicle from the visual information gathered in a camera system.

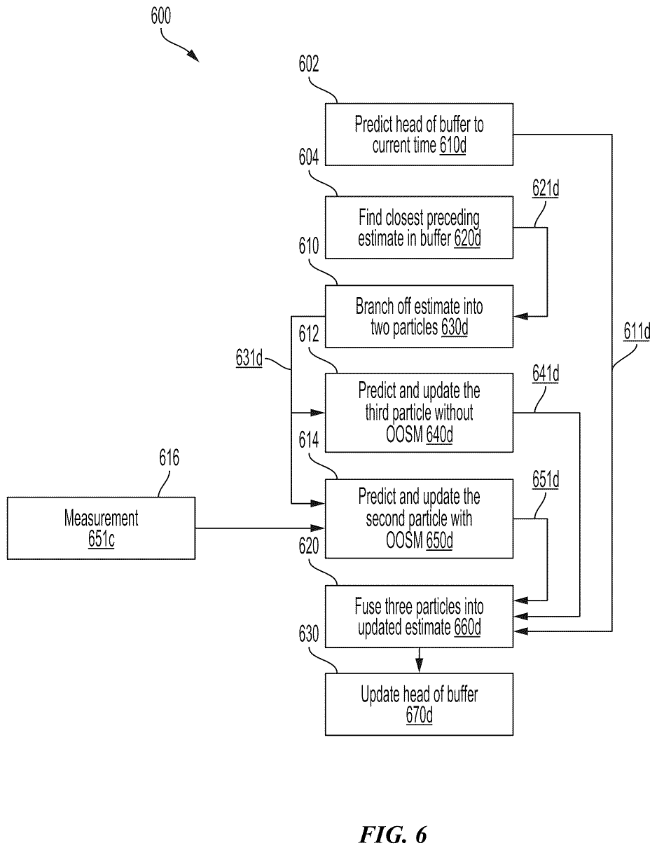

Application of the OOSM method to driving technologies exhibits a significant speedup (e.g., on the order of 10-20×) in the context of sensor suites and estimation algorithms used in driving, where lightweight predictions can be used in the forward prediction of the tracklets. Furthermore, the proposed OOSM method may be configured for parallelization under certain assumptions. For example, some implementations involve advanced driver assistance systems (ADAS) and autonomous driving (AD) features, in which the OOSM method essentially acts as an estimator in a late fusion setting, fusing various sensing modalities into a description of the vehicle state. An OOSM vehicle state estimation process is illustrated, for example, in FIGS. 6-9.

FIG. 6 is a flowchart illustrating an out of sequence measurement (OOSM) vehicle state estimation process 600, according to various aspects of the present disclosure. As shown in FIG. 6, at block 602, a head of a measurements buffer is predicted to current time 610d. As shown in FIG. 6, instead of updating with all of the measurements in a measurement buffer, the most recent measurement is used for the measurement update. To this end, the process 600 starts by predicting the head of the buffer forward at block 602, creating, for example, a Gaussian-Inverse-Wishart particle “A” 610d. Based on the sample time in the OOSM, at block 604, the closest preceding estimate in the buffer is branched off 620d into two new particles “B” and “C.” At block 614, the particle “B” (e.g., second particle) is predicted forward including the OOSM 650d, and, at block 612, the particle “C” (e.g., third particle) is predicted forward to the current time excluding the OOSM 640d. In this example, the OOSM is shown as measurement 651c, at block 616.

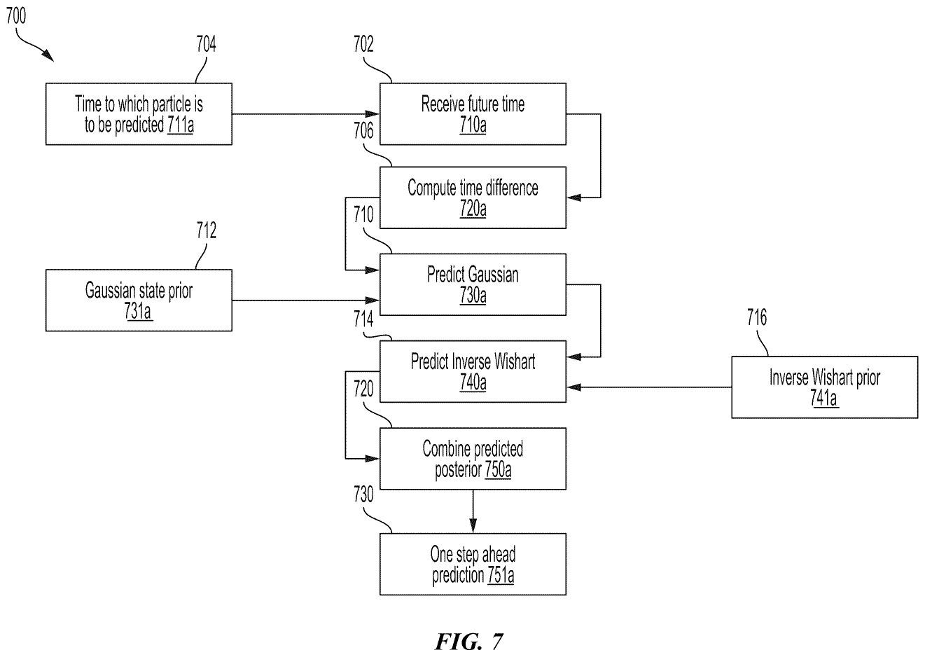

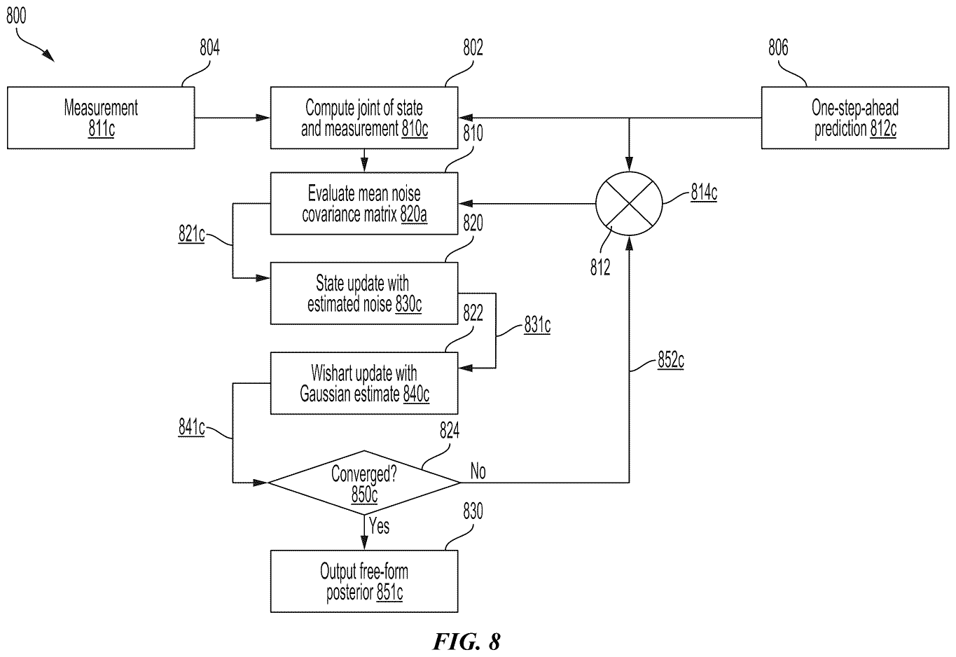

As further illustrated in FIG. 6, at block 620, the three particles are fused using the updated equations in Proposition 1 and 2 into an updated estimate in 660d. Additionally, at block 630, the updated estimate replaces the head of the buffer 670d and concludes the processing of the OOSM. In various aspects of the present disclosure, the predictions performed in blocks 612 and 614 may be performed using the process shown in FIG. 7. Additionally, the updates performed at blocks 620 and 630 may be performed using the process shown in FIG. 8.

FIG. 7 is a flowchart illustrating a process 700 for prediction of an Inverse Wishart-Gaussian particle, according to various aspects of the present disclosure. The process 700 begins at block 702, in which a future time is received in 710a from block 704, in which a time to which a particle is predicted (e.g., a prediction time) is provided in 711a. At block 706, a time difference between the future time and the predicted time is computed. At block 710 a Gaussian is predicted based on the time difference computed in 720a and a Gaussian state prior 731a from block 712. At block 714 an Inverse Wishart is predicted based on the predicted Gaussian in 730a, and at block 716 Inverse Wishart priors 741a are predicted forward in time based on a time difference computed in 720a and combined with a predicted posterior at 750a in block 720, producing a one-step-ahead prediction 751a at block 730. According to various aspects of the present disclosure, multiple one-step-ahead predictions can be combined to produce a multi-step-ahead prediction. Alternatively, student-t distributions and inverse Gamma distributions, and other like distributions are contemplated according to aspects of the present disclosure.

FIG. 8 is a flowchart illustrating a process for updating an Inverse-Wishart-Gaussian particle, according to various aspects of the present disclosure. A process 800 begins at block 802, in which a joint density of a state and measurement is computed in 810c based on the one-step ahead prediction 812c at block 806 and a measurement model 811c at block 804. At block 810, a mean noise covariance matrix is evaluated 820a from the Inverse-Wishart one-step ahead prediction 812c on the first iteration, or the previous iteration 852c with the selector in 814c at block 812. Based on the evaluated noise covariance matrix from block 810, at block 820, a state measurement update is performed, passing the parameters of a state distribution 831c, which are used to update the parameters of the noise covariance distribution 840c at block 822. The updated state and noise covariance parameters 841c are passed through a convergence check 850c at block 824. If the estimates have converged, the free-form posterior is formed and outputted 851c at block 830. Otherwise, the updated estimates are passed back to the block 812 (e.g., a selector block) as previous iteration 852c for the next fixed-point iteration at block 810.

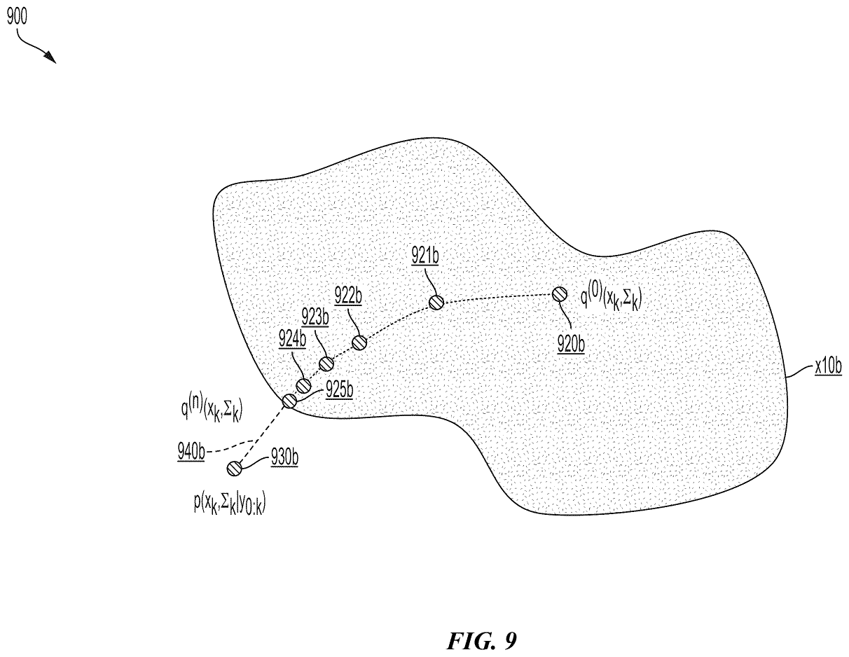

FIG. 9 is a diagram illustrating variational updates 900, according to various aspects of the present disclosure. As shown in FIG. 9, an initial guess of the posterior based on the forward prediction 920b residing in the variational family of choice 910b is steered to a target posterior 930b by a set of fixed-point iterations. This process is performed by minimizing a divergence 940b between the density q(l) and the target posterior 930b. In one implementation, the iterations 920b, 921b, 922b, 923b, 924b, 925b, reside with the variational family of choice 910b, composed of independent Gaussian and Inverse-Wishart distributions. In this example, the iterations 920b, 921b, 922b, 923b, 924b, 925b are computed until a sufficiently large number n, at which point the divergence of choice is minimized. In some implementations, this divergence is chosen as the Kullback-Leibler divergence.

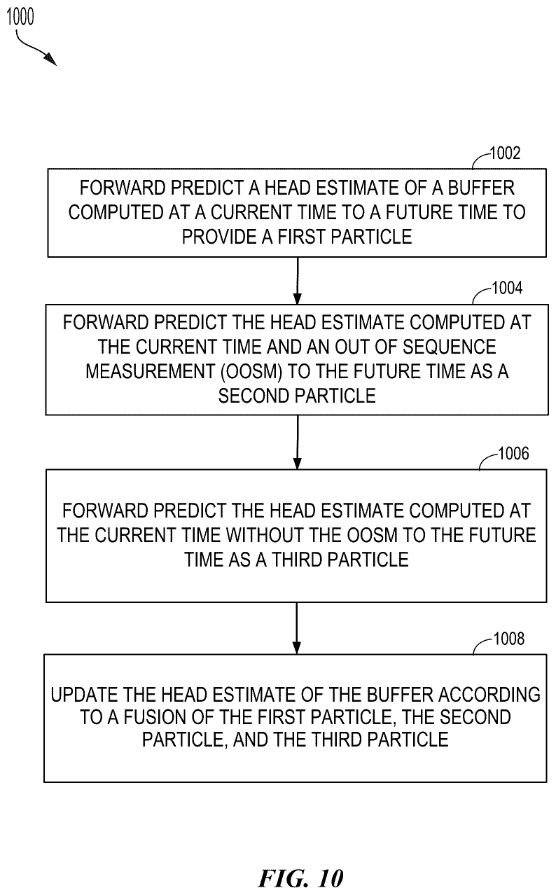

According to various aspects of the present disclosure, vehicle state estimation is performed, in which at least one vehicle measurement arrives out of sequence, and in which another vehicle measurement arrives in sequence. A method for an out of sequence measurement (OOSM) vehicle state estimation is shown, for example, in FIG. 10.

FIG. 10 is a flowchart illustrating a method 1000 for an out of sequence measurement (OOSM) vehicle state estimation, according to aspects of the present disclosure. The method 1000 begins at block 1002, in which a head estimate of a buffer computed at a current time is forward predicted to a future time to provide a first particle. For example, as shown in FIG. 5, a current estimate 520 at a time k−1 is computed using the measurement set A and predicted forward to a time k (tₖ) to provide a first particle 540.

At block 1004, the head estimate computed at the current time and an out of sequence measurement (OOSM) are forward predicted to the future time as a second particle. At block 1006, the head estimate computed at the current time without the OOSM is forward predicted to the future time as a third particle. For example, as shown in FIG. 5, an out of sequence measurement (OOSM) 530 arriving at a time k (kₖ) is sampled at some previous time s (sₖ), and the current estimate 520 is branched-off at the time kappa (kₖ), producing two additional particles, both computed with the measurements C=A∩B. A second particle 550 is predicted forward to the time k using the measurements B, and a third particle 560 is predicted forward to the time k using the measurements C.

At block 1008, the head estimate of the buffer is updated according to a fusion of the first particle, the second particle, and the third particle. For example, as shown in FIG. 5, fusion 570 of the three particles is performed at the time k, in which the information in C is subtracted from the information in B, before being added to A. In some implementations, subtracting information associated with the third particle 560 from the second particle 550 is performed prior to adding a difference to the first particle 540.

According to various aspects of the present disclosure, an OOSM method estimates system state and noise statistics using out-of-sequence measurements, which is particularly beneficial for applications with delayed and unreliable measurements. Additionally, the OOSM method estimate the state factor and noise statistics of a system using out-of-sequence measurements. For example, the OOSM method involves propagating an estimate forward in time, decorrelating it with another predicted estimate, and fusing the two. The invention is particularly useful for applications with delayed and unreliable measurements, such as in driving technologies. The method allows for instantaneous estimation of the system state and noise statistics.

In some aspects of the present disclosure, the method shown in FIG. 10 may be performed by the SOC 100 (FIG. 1) or the software architecture 200 (FIG. 2) of the vehicle 150. That is, each of the elements or methods may, for example, but without limitation, be performed by the SOC 100, the software architecture 200, the processor (e.g., CPU 102), and/or other components included therein of the vehicle 150, or the OOSM vehicle state estimation system 300.

The various operations of the methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for out of sequence measurement (OOSM) state estimation, the method comprising:
forward predicting a head estimate of a buffer computed at a current time to a future time to provide a first particle;
forward predicting the head estimate computed at the current time and an out of sequence measurement (OOSM) to the future time as a second particle;
forward predicting the head estimate computed at the current time without the OOSM to the future time as a third particle; and
updating the head estimate of the buffer according to a fusion of the first particle, the second particle, and the third particle.

2. The method of claim 1, further comprising estimating a vehicle state according to the fusion of the first particle, the second particle, and the third particle.

3. The method of claim 2, in which estimating the vehicle state further comprises variational filtering of OOSMs from the fusion of the first particle, the second particle, and the third particle.

4. The method of claim 3, in which OOSMs comprise velocity information from a brake electronic control unit (ECU) of a vehicle, measurements from a global navigation satellite system (GNSS) positioning module, and/or optical flow and auxiliary measurements computed from a camera system.

5. The method of claim 1, further comprising determining an uncertainty of a vehicle state estimation model in response to OOSMs.

6. The method of claim 1, in which prior to the updating, the method further comprises branching the head estimate computed at the current time to enable computation of the second particle and the third particle.

7. The method of claim 1, in which updating comprises subtracting information associated with the third particle from the second particle prior to adding a difference to the first particle.

8. The method of claim 1, further comprising performing late fusion of multiple sensing modalities, including RADAR, LiDAR, GNSS, optical Flow, vision information, and/or an inertial measurement unit (IMU) information.

9. The method of claim 1, further comprising estimating a state of a vehicle, in which at least one vehicle measurement arrives out of sequence, and in which another vehicle measurement arrives in sequence.

10. A non-transitory computer-readable medium having program code recorded thereon for out of sequence measurement (OOSM) state estimation, the program code being executed by a processor and comprising:
program code to forward predict a head estimate of a buffer computed at a current time to a future time to provide a first particle;
program code to forward predict the head estimate computed at the current time and an out of sequence measurement (OOSM) to the future time as a second particle;
program code to forward predict the head estimate computed at the current time without the OOSM to the future time as a third particle; and
program code to update the head estimate of the buffer according to a fusion of the first particle, the second particle, and the third particle.

11. The non-transitory computer-readable medium of claim 10, further comprising program code to estimate a vehicle state according to the fusion of the first particle, the second particle, and the third particle.

12. The non-transitory computer-readable medium of claim 11, in which the program code to estimate the vehicle state further comprises program code to incorporate OOSMs from the fusion of the first particle, the second particle, and the third particle.

13. The non-transitory computer-readable medium of claim 12, in which the OOSMs comprise velocity information from a brake electronic control unit (ECU) of a vehicle, measurements from a global navigation satellite system (GNSS) positioning module, and/or optical flow and auxiliary measurements computed from a camera system.

14. The non-transitory computer-readable medium of claim 10, further comprising program code to determine an uncertainty of a vehicle state estimation model in response to OOSMs.

15. The non-transitory computer-readable medium of claim 10, in which prior to the program code to update, the non-transitory computer-readable medium further comprises program code to branch the head estimate computed at the current time to enable computation of the second particle and the third particle.

16. The non-transitory computer-readable medium of claim 10, in which the program code to update comprises program code to subtract information associated with the third particle from the second particle prior to adding a difference to the first particle.

17. The non-transitory computer-readable medium of claim 10, further comprising program code to perform late fusion of multiple sensing modalities, including RADAR, LiDAR, GNSS, optical Flow, vision information, and/or an inertial measurement unit (IMU) information.

18. The non-transitory computer-readable medium of claim 10, further comprising program code to estimate a state of a vehicle, in which at least one vehicle measurement arrives out of sequence, and in which another vehicle measurement arrives in sequence.

19. A system for out of sequence measurement (OOSM) state estimation, the system comprising:
a head estimate prediction module to forward predict a head estimate of a buffer computed at a current time to a future time to provide a first particle;
a head estimate branching model to forward predict the head estimate computed at the current time and an out of sequence measurement (OOSM) to the future time as a second particle and to forward predict the head estimate computed at the current time without the OOSM to the future time as a third particle;
a particle fusion module to update the head estimate of the buffer according to a fusion of the first particle, the second particle, and the third particle; and
a vehicle state estimation module to estimate a vehicle state based on the updated head estimate of the buffer according to the fusion of the first particle, the second particle, and the third particle.

20. The system of claim 19, in which the vehicle state estimation module is further to incorporate OOSMs from the fusion of the first particle, the second particle, and the third particle.

21. The system of claim 20, in which the OOSMs comprise velocity information from a brake electronic control unit (ECU) of a vehicle, measurements from a global navigation satellite system (GNSS) positioning module, and/or optical flow and auxiliary measurements computed from a camera system of the vehicle.

22. The system of claim 19, in which the vehicle state estimation module is further to estimate the vehicle state, in which at least one vehicle measurement arrives out of sequence, and in which another vehicle measurement arrives in sequence.
